(19) United States
(12) Patent Application Publication
(10) Pub. No.: US 2004/0252087 A1
(43) Pub. Date: Dec. 16, 2004

(54) Drive device and drive method for light emitting display panel

(75) Inventor: Naoki Yazawa, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 10/849,370

(22) Filed: May 20, 2004

(30) Foreign Application Priority Data
Jun. 11, 2003 (JP) 2003-165928

(51) Int. Cl. G09G 3/30

(52) U.S. Cl. 345/76; 345/204

(57) ABSTRACT

The present invention is to provide a drive device and a drive method of a self light emitting display panel which can dissolve at low cost a technical problem which occurs due to the provision of constant current sources in a lighting driving circuit of a display panel. A scan driver 3 and a data driver 10 set all scan lines K1 to Km and all data lines A1 to An arranged on the display panel 1 at the same electrical potential at a switching time of scan so that a reset operation for discharging electrical charges accumulated in parasitic capacitances of respective light emitting elements E11 to Enm is performed. Charge current which follows the reset operation, which is from a driving voltage source 4, which charges the parasitic capacitances of the light emitting elements in the non-scan state is supplied as a forward current to a light emitting element which is scanned and lit so that this light emitting element is driven to emit light, utilizing the driving voltage source 4.

### BACKGROUND OF THE INVENTION

1. Field of the Invention

The present invention relates to a drive device and a drive method for a light emitting display panel in which for example an organic EL (electroluminescent) element is employed as a light emitting element, and particularly to a passive drive type drive device and a drive method in which a constant current source which drives lighting of light emitting elements is not needed and in which the utilization efficiency of a power source can be improved.

2. Description of the Related Art

A display panel which is constructed by arranging light emitting elements in a matrix pattern has been developed widely, and as the light emitting element employed in such a display panel, an organic EL element in which an organic material is employed in a light emitting layer has attracted attention. This is because of backgrounds one of which is that by employing, in the light emitting layer of the element, an organic compound which enables an excellent light emitting characteristic to be expected, a high efficiency and a long life which make an EL element satisfactorily practicable have been achieved.

The organic EL element can be electrically shown by an equivalent circuit as shown in FIG. 1. That is, the organic EL element can be replaced by a structure composed of a diode element E and a parasitic capacitance element Cp which is coupled in parallel to this diode element, and the organic EL element has been considered as a capacitive light emitting element. When a light emission drive voltage is applied to this organic EL element, at first, electrical charges corresponding to the electric capacity of this element flow into an electrode as a displacement current and are accumulated. It can be considered that when the voltage then exceeds a determined voltage (light emission threshold voltage=Vth) peculiar to the element in question, current begins to flow from the electrode (anode side of the diode element E) to an organic layer constituting the light emitting layer so that the element emits light at an intensity proportional to this current.

FIG. 2 shows light emission static characteristics of such an organic EL element. According to these, the organic EL element emits light at an intensity L approximately proportional to a drive current I as shown in FIG. 2(a) and emits light while the current I flows drastically when the drive voltage V is the light emission threshold voltage Vth or higher as shown in FIG. 2(b). In other words, when the drive voltage is the light emission threshold voltage Vth or lower, current rarely flows in the EL element, and the EL element does not emit light. Therefore, the EL element has an intensity characteristic that in a light emission possible region in which the voltage is higher than the threshold voltage Vth, the greater the value of the voltage V applied to the EL element becomes, the higher the light emission intensity L of the EL element becomes as shown by the solid line in FIG. 2(c).

It has been known that the intensity property of the organic EL element changes due to environmental temperature changes approximately as shown by dotted lines in FIG. 2(c). That is, while the EL element has a characteristic that the greater the value of the voltage V applied thereto, the higher the light emission intensity L thereof in the light emission possible region in which the voltage is higher than the light emission threshold voltage as described above, the EL element also has a characteristic that the higher the temperature becomes, the lower the light emission threshold voltage becomes. Accordingly, the EL element becomes in a state where light emission of the EL element is possible by a lower applied voltage as the temperature becomes higher, and thus the EL element has a temperature dependency of the intensity that the EL element is brighter at a high temperature time and is darker at a lower temperature time though the same light emission possible voltage is applied.

In general, a constant current drive is performed for the organic EL element due to the reason that the voltage vs. intensity characteristic is unstable with respect to temperature changes as described above while the current vs. intensity characteristic is stable with respect to temperature changes, the reason that the organic EL element is drastically deteriorated in a case where the organic EL element receives an excess current, and the like. As a display panel employing such organic EL elements, a passive drive type display panel in which the elements are arranged in a matrix pattern has already been put into practical use partly.

In FIG. 3, a conventional passive matrix type display panel and an example of its drive circuit are shown. There are two methods that are a cathode line scan/anode line drive and an anode line scan/cathode line drive in drive methods for organic EL elements in the passive matrix drive system, and the structure shown in FIG. 3 shows a form of the former cathode line scan/anode line drive. That is, anode lines A1 to An as n data lines are arranged in a vertical direction, cathode lines K1 to Km as m scan lines are arranged in a horizontal direction, and organic EL elements E11 to Enm which are denoted by symbols/marks of diodes are arranged at portions at which respective lines intersect one another (in total, n×m portions) to constitute a display panel 1.

One ends (anode terminals in equivalent diodes of the EL elements) and other ends (cathode terminals in the equivalent diodes of the EL elements) of the respective EL elements E11 to Enm constituting pixels are connected to the anode lines and cathode lines, respectively, corresponding to respective crossing positions between the anode lines A1 to An extending along the vertical direction and the cathode lines K1 to Km extending along the horizontal direction. Further, the respective anode lines A1 to An are connected to an anode line drive circuit 2 provided as a data driver, and the respective cathode liens K1 to Km are connected to a cathode line scan circuit 3 provided as a scan driver, so as to be driven, respectively.

The anode line drive circuit 2 is provided with constant current sources I1 to In which are operated utilizing a drive voltage VH supplied from a voltage boosting circuit 4 in a later-described DC/DC converter and drive switches Sa1 to San, and the drive switches Sa1 to San are connected to the constant current sources I1 to In sides so that current from the constant current sources I1 to In is supplied to the respective EL elements E11 to Enm arranged corresponding to the cathode lines. The drive switches Sa1 to San are constructed in such a way that the anode lines can be connected to the ground side provided as a reference potential point when current from the constant current sources I1 to In is not supplied to the respective EL elements.

The cathode line scan circuit 3 is provided with scan switches Sk1 to Skm corresponding to the respective cathode lines K1 to Km and operates so as to allow either one of a reverse bias voltage VM supplied from a later-described reverse bias voltage generation circuit 5 which is for preventing cross talk light emission or the ground potential as the reference potential point to be connected to corresponding cathode scan lines. Thus, by connecting the constant current sources I1 to In to desired anode lines A1 to An while the cathode lines are set at the reference potential point (ground potential) at predetermined cycles, light of the respective EL elements are selectively emitted.

Meanwhile, the above-mentioned DC/DC converter is constructed so as to generate the drive voltage VH of a direct current while utilizing PWM (pulse width modulation) control as the voltage boosting circuit 4 in the example shown in FIG. 3. For this DC/DC converter, well-known PFM (pulse frequency modulation) control or PSM (pulse skip modulation) control can also be utilized instead of the PWM control.

This DC/DC converter is constructed in such a way that a PWM wave outputted from a switching regulator 6 constituting a part of the voltage boosting circuit 4 controls so that a MOS type power FET Q1 as a switching element is turned ON at a predetermined duty cycle. That is, by the ON operation of the power FET Q1, electrical energy from a DC voltage source B1 of a primary side is accumulated in an inductor L1, and the electrical energy accumulated in the inductor L1 is accumulated in a capacitor C1 via a diode D1 as an OFF operation of the power FET Q1. By repeating of the ON/OFF operation of the power FET Q1, a DC output whose voltage is boosted can be obtained as a terminal voltage of the capacitor C1.

The DC output voltage is divided by a thermistor TH1 performing temperature compensation and resistors R11 and R12, is supplied to an error amplifier 7 in the switching regulator 6, and is compared with a reference voltage Vref in this error amplifier 7. This comparison output (error output) is supplied to a PWM circuit 8, and by controlling the duty cycle of a signal wave produced from an oscillator 9, feedback control is performed so that the output voltage is maintained at a predetermined drive voltage VH. Therefore, the output voltage by the DC/DC converter, that is, the drive voltage VH, can be expressed as follows.

VH=Vref×[(TH1+R11+R12)/R12]

Meanwhile, the reverse bias voltage generation circuit 5 utilized for preventing the cross talk light emission is constituted by a voltage divider circuit which divides the drive voltage VH. That is, this voltage divider circuit is composed of resistors R13, R14 and a npn transistor Q2 that functions as an emitter follower so that the reverse bias voltage VM is obtained in the emitter of the transistor Q2. Therefore, when the base-emitter voltage in the transistor Q2 is represented by Vbe, the reverse bias voltage VM obtained by the voltage divider circuit can be expressed as follows.

VM=VHx [R14/(R13+R14)]−Vbe

A control bus extended from a light emission control circuit including an unillustrated CPU is connected to the anode line drive circuit 2 and the cathode line scan circuit 3, and the scan switches Sk1 to Skm and the drive switches Sa1 to San are operated based on a video signal to be displayed. Thus, while the cathode scan lines are set at the ground potential at predetermined cycles based on the video signal, the constant current sources I1 to In are connected to a desired anode line. Accordingly, the light emitting elements selectively emit light, and thus an image based on the video signal is displayed on the display panel 1.

The state shown in FIG. 3 shows that the first cathode line K1 is set at the ground potential to be in a scan state and that at this time the reverse bias voltage VM from the reverse bias voltage generation circuit 5 is applied to the cathode lines K2 to Km in a non-scan state. This works so that respective light emitting elements connected to the intersection points between the driven anode lines and the cathode lines which haven not been selected for scan are prevented from emitting cross talk light.

The passive drive type display panel of the structure shown in FIG. 3 described above and the drive circuit therefor are disclosed in Japanese Patent Application Laid-Open No. 2003-76328 (paragraphs 0007 through 0020 and FIG. 6) shown below that the present applicant has already filed.

In the drive circuit of the conventional typical display panel shown in FIG. 3, the constant current sources I1 to In for driving light emission of EL elements are provided. Even when these constant current sources are made into an IC chip, it is difficult for the chip size thereof to be miniaturized, and it cannot be avoided that the cost thereof also increases. Further, in order to allow the constant current sources to have a constant current characteristic, it is necessary to anticipate a certain degree of voltage drop in the constant current source, and this becomes a primary factor to incur a power loss. Although the respective constant current sources I1 to In have been made into an IC chip already as described above in the present state of art, it cannot be avoided that variations in its current values occur, and thus a problem that for example intensity slope and the like in a horizontal direction along the scan lines occurs and the like is brought about.

In order to dissolve the problem of intensity slope and the like due to variations in the current values, although a countermeasure that the current values of the respective constant current sources are respectively controlled may be considered, since the above-described organic EL element is operated at about several tens microamperes, it is very difficult to correct variations of such relatively faint current values. Although it may be considered that the EL elements are driven by a constant voltage in order to avoid the above-described problem due to the provision of the constant current sources, this case incurs a problem where the intensity changes extremely largely due to the environmental temperature as described above.

### SUMMARY OF THE INVENTION

The present invention is to solve the above-described technical problems which occur by the provision of constant current sources in a drive circuit, and it is an object of the present invention to provide a drive device and a drive method for a self light emitting display panel by which any intensity change with respect to the environmental temperature can be easily restrained or deliberately controlled and by which ideal multi-gradation expression can be realized at low cost.

A drive device of a light emitting display panel in the present invention which has been developed in order to achieve the object described above is, according to a first aspect, a drive device of a light emitting display panel provided with a plurality of data lines and a plurality of scan lines which intersect one another and capacitive light emitting elements having a diode characteristic which are respectively connected, between the data lines and respective scan lines, at intersecting positions between the respective data lines and the respective scan lines, characterized in that scan is implemented one after another by connecting the respective scan lines to a scan potential point and that a scan driver which connects a scan line of a non-scan state which is not connected to the scan potential point to a driving voltage source and a data driver which controls lighting or non-lighting of the respective light emitting elements of a scan state in synchronization with a scan of the scan driver are provided, and characterized by being constructed in such a way that the scan driver and the data driver set all scan lines and all data lines at a same electrical potential when a scan is switched so that electrical charges accumulated in parasitic capacitances of the respective light emitting elements are discharged and that charge current which follows the discharge of electrical charges, which is from the driving voltage source, and which charges parasitic capacitances of light emitting elements in the non-scan state is supplied as a forward current to a light emitting element which is scanned and lit so that the light emitting element is driven to emit light, utilizing the driving voltage source.

A drive method of a light emitting display panel in the present invention which has been developed in order to achieve the object described above is, according to a ninth aspect, a drive method of a light emitting display panel provided with a plurality of data lines and a plurality of scan lines which intersect one another and capacitive light emitting elements having a diode characteristic which are respectively connected, between the data lines and respective scan lines, at intersecting positions between the respective data lines and respective scan lines, characterized by performing a reset process in which while the scan lines of the display panel are scanned at predetermined cycles, lighting or non-lighting of the respective light emitting elements of a scan state is controlled in synchronization with the scan and in which all scan lines and all data lines are set at a same electrical potential when the scan is switched so that electrical charges accumulated in parasitic capacitances of the respective light emitting elements are discharged and a process which follows this reset process and in which parasitic capacitances of light emitting elements in a non-scan state are charged, utilizing a drive voltage of a driving voltage source, the charge current being supplied to an light emitting element which is scanned and lit as a forward current so that a light emitting element in the display panel is driven to emit light by the charge current.

### BRIEF DESCRIPTION OF THE DRAWINGS

FIG. 1 is an equivalent circuit diagram of an organic EL element;

FIG. 2 is static characteristics graphs showing respective characteristics of an organic EL element;

FIG. 3 is a connection diagram showing a drive device of a display panel in the prior art;

FIG. 4 is a connection diagram showing a first embodiment of a drive device according to the present invention;

FIG. 5 is equivalent circuit diagrams explaining a reset operation in the drive device shown in FIG. 4;

FIG. 6 is a connection diagram showing a second embodiment of a drive device according to the present invention;

FIG. 7 is a connection diagram showing a third embodiment of a drive device according to the present invention; and

FIG. 8 is a timing table of respective switches explaining operations mainly of a revival means in the third embodiment shown in FIG. 7.

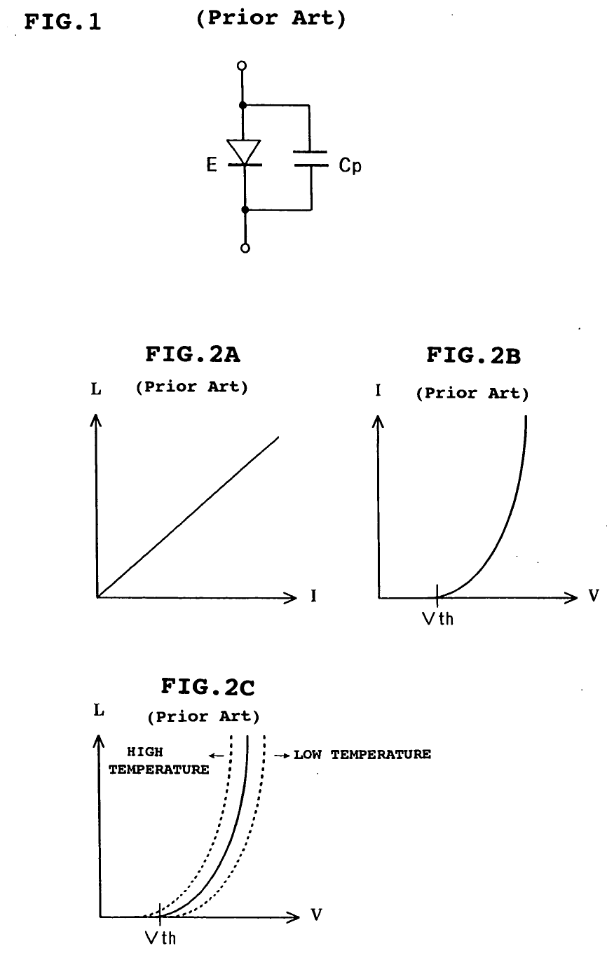

### DESCRIPTION OF THE PREFERRED EMBODIMENTS

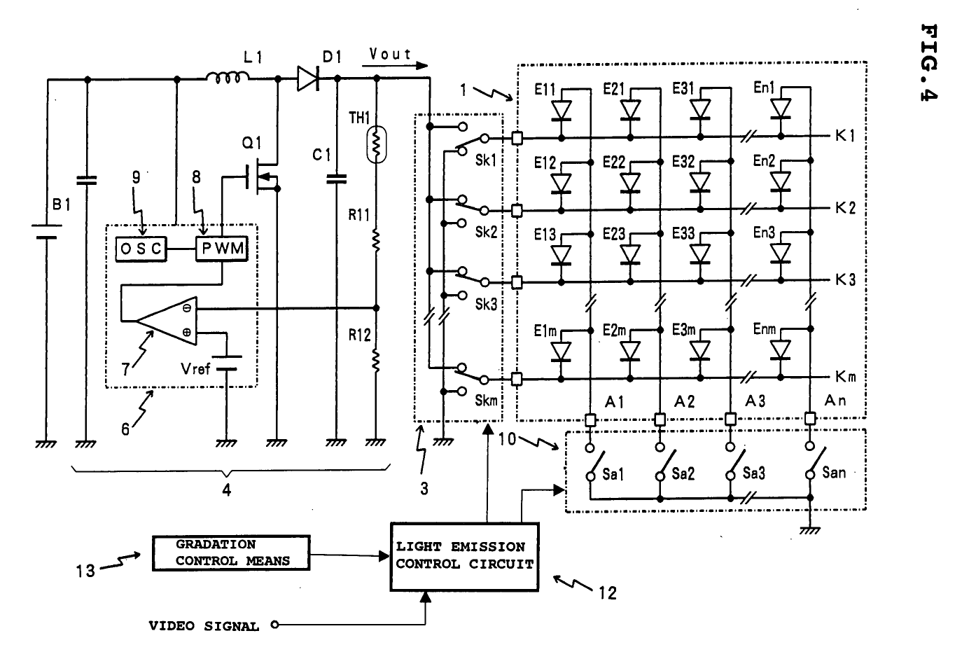

Preferred embodiments of a drive device of a light emitting display panel according to the present invention will be described below with reference to the drawings. FIG. 4 shows a first embodiment thereof.

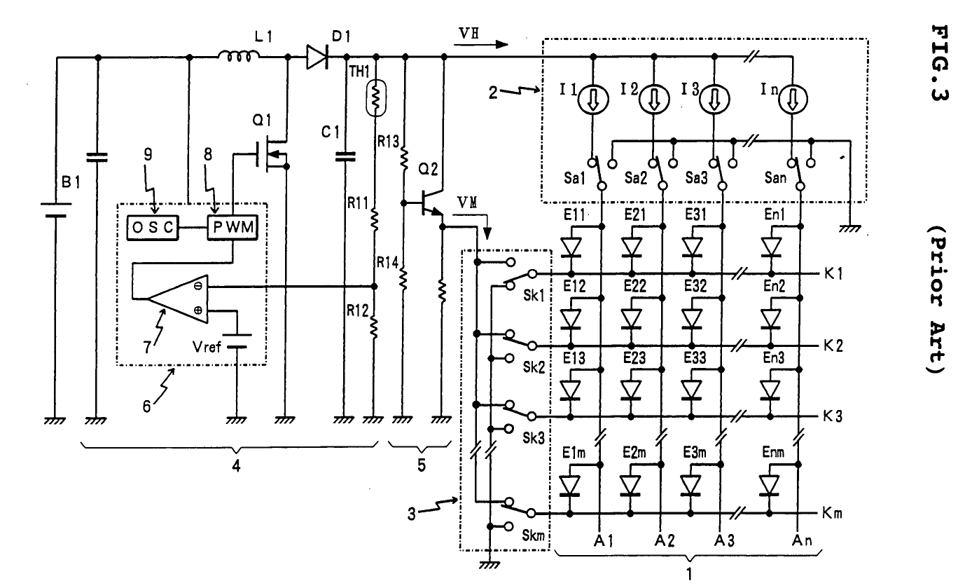

In FIG. 4, similarly to FIG. 3 which has already been described, a plurality of anode lines A1 to An as data lines are arranged in a vertical direction, and a plurality of cathode lines K1 to Km as scan lines are arranged in a horizontal direction. Organic EL elements E11 to Enm are arranged in a matrix pattern at respective crossing points between respective anode lines and cathode lines. That is, the structure of FIG. 4 is composed of a plurality of data lines and a plurality of scan lines intersecting one another and capacitive light-emitting elements (organic EL elements) having a diode characteristic which are respectively connected, between the data lines and respective scan lines, at intersecting positions between the respective data lines and respective scan lines.

In FIG. 4, parts corresponding to respective constituent elements shown in FIG. 3 already described are designated by the like numerals, and therefore detailed explanation thereof will be omitted appropriately.

Compared to the conventional structure shown in FIG. 3, in the embodiment shown in this FIG. 4, the constant current sources I1 to In for driving lighting of the EL elements E11 to Enm as light emitting elements are omitted, and an output voltage Vout of a voltage boosting circuit 4 by a DC/DC converter is utilized as a voltage source for driving a display panel 1. That is, the output voltage Vout from a driving voltage source is supplied to a scan driver 3 that is a cathode line scan circuit and is applied to the EL elements E11 to Enm as a reverse bias.

Scan switches Sk1 to Skm are provided in the scan driver 3, corresponding to the respective scan lines K1 to Km, and a light emission control circuit 12 implements control for connecting the scan switches Sk1 to Skm of the scan driver 3 selectively to a scan potential point, that is, a ground potential, whereby scan is performed sequentially. At this time the output voltage Vout from the driving voltage source as the voltage boosting circuit 4 is applied to the respective scan lines of a non-scan state.

Meanwhile, the respective data lines A1 to An arranged on the display panel 1 are constructed so as to be controlled by a data driver 10. That is, drive switches Sa1 to San are arranged in the data driver 10, corresponding to the respective drive lines A1 to An, and the respective switches Sa1 to San are turned on so that the data lines A1 to An are connected to the ground provided as a reference potential point of the circuit. The respective switches Sa1 to San are turned off so that the data lines A1 to An are set in an open state.

A control bus is connected to the scan driver 3 and the data driver 10 from the light emission control circuit 12 including a CPU, and the scan driver 3 receives a command from the light emission control circuit 12 to repeat the above-described scan operation sequentially. The data driver 10 controls the drive switches Sa1 to San so that the switches Sa1 to San are turned ON/OFF based on a video signal which is supplied to the light emission control circuit 12 in synchronization with the scan of the scan driver 3 to control the lighting or non-lighting of respective light emitting elements in a scan state. Thus, as described in detail later, the respective EL elements arranged on the display panel 1 are allowed to selectively emit light, and an image based on the video signal is displayed on the display panel 1.

A gradation control means 13 is connected to the light emission control circuit 12, and by a gradation control signal supplied from this gradation control means 13, the circuit 12 is constructed to control the gradation of an image drawn on the display panel. A gradation control method in this embodiment will be described later in detail.

In the above-described structure, in order to drive light emission of the respective EL elements arranged on the display panel 1, by setting all scan lines K1 to Km and all data lines A1 to An at the same electrical potential at the time of switching of scan in which scan lines are sequentially scanned, a reset process in which electrical charges accumulated in the parasitic capacitances of the respective light emitting elements are discharged is executed. After this reset process, executed is a process in which the parasitic capacitances of the light emitting elements in the non-scan state are charged utilizing the drive voltage Vout from the driving voltage source and in which this charge current is supplied as forward current to the light emitting elements which are scanned and lit.

Thus, the current charged in the parasitic capacitances of the light emitting elements which are not scan objects is supplied as rush current to the light emitting elements which are scanned and lit via the respective data lines. Accordingly, the light emitting elements which are scanned and lit are driven to emit light by the rush current.

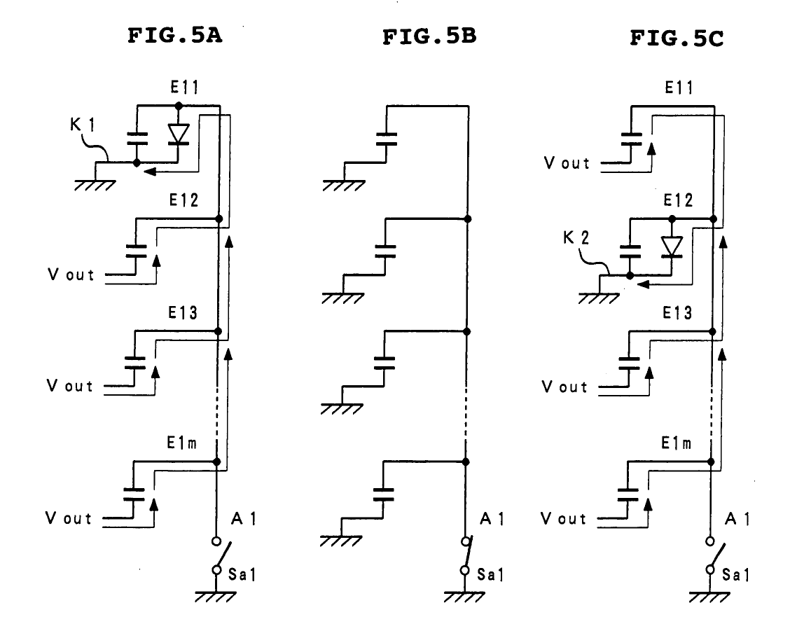

FIG. 5 explains the above-described reset operation and the operation in which the light emitting elements, which are scanned and lit, are driven to emit light by the rush current generated by the reset operation. FIG. 5 shows from a state in which the EL element E11 connected to the first data line A1 is driven to emit light to a state in which the EL element E12 connected to the same first data line A1 is driven to emit light in the next scan. In FIG. 5, the EL elements which are driven to emit light are denoted by symbols/marks of diodes and other EL elements are denoted by symbols/marks of capacitors as parasitic capacitances.

FIG. 5(a) shows a prior state of the reset operation and shows a state in which the first scan line K1 is scanned and the EL element E11 emits light. At this time, as illustrated in (a), the drive switch Sa1 in the data driver 10 is in the open state. The output voltage Vout from the driving voltage source is applied to the respective cathode terminals of the EL elements E13 to E1m in the non-scan state via the scan switches Sk2 to Skm. The cathode terminal of the EL element E11 in the scan state is the scan reference potential (ground potential).

As a result, as shown by the arrows in FIG. 5(a), current for charging respective parasitic capacitances in the EL elements E12 to E1m in the non-scan state flows from the drive voltage Vout from the driving voltage source, and this current gathers in the first data line A1 to be supplied as the rush current to the EL element E11 in the scan state in the forward direction. Therefore, the EL element E11 is driven to emit light by this rush current.

At the time of switching of the next scan, as shown in FIG. 5(b), a reset operation in which all scan lines and all data lines are set at the same electrical potential is executed. That is, in this embodiment, the respective drive switches Sa1 to San in the data driver 10 are all turned on to be connected to the ground, and the respective scan switches Sk1 to Skm in the scan driver 3 are all connected also to the ground side. Thus, electrical charges accumulated in the parasitic capacitances of the respective light emitting elements are momentarily discharged.

Next, the second scan line K2 is scanned in order to allow the EL element E12 to emit light. That is, the second scan line K2 is connected to the ground, and the output voltage Vout from the driving voltage source is given to the other scan lines. At this time, the drive switch Sa1 is in the open state. As a result, as shown by the arrows in FIG. 5(c), current for charging the respective parasitic capacitances in the EL elements E11, E13 to E1m in the non-scan state flows, and this current gathers in the first data line A1 to be supplied as the rush current to the EL element E12 in the scan state in the forward direction. Accordingly, the EL element E12 is driven to emit light by this rush current.

At this time, since a charge direction of electrical charges charged in the parasitic capacitances of the EL elements in the non-scan state is a reverse bias direction, there is no risk that the EL elements E11, E13 to E1m in the non-scan state emit light erroneously. As can be understood by the above explanation, when an EL element which is scanned is driven to emit light, as shown in FIGS. 5(a) and 5(c), the drive switch Sa1 is controlled to be turned off.

Conversely, when EL elements, which are scanned are not driven to emit light, the drive switch Sa1 in FIGS. 5(a) and (c) is controlled to be turned on. Thus, the charge current flowing in the data line A1 is all dropped to the ground, so that the forward voltage to EL elements to be scanned is not generated. Although the above is described in which respective EL elements connected to the first data line A1 are objects, light emission driving operations are performed for respective EL elements connected to the other data lines A2 to An through similar operations.

Light emission energy given to EL elements which are driven to emit light by the above-described operations is defined by the number of respective EL elements which are not objects of scan, the parasitic capacitances thereof and the drive voltage Vout from the driving voltage source. This light emission energy determines momentary intensity of an EL element, which is driven to emit light by one scan. Therefore, the more the number of repeating times of the scan during a unit time (this may be expressed as a duty cycle), the higher the entire intensity level becomes, and the less the number of repeating times of the scan the lower the entire intensity level becomes.

Meanwhile, in the case where respective EL elements arranged on the light emitting display panel 1 is constructed as a dot matrix, since forming films of EL elements is performed by a deposition means, a state of relatively less variations can be obtained. In other words, it is possible to form parasitic capacitances corresponding to respective pixels in a state in which variations are not so much. Accordingly, under the condition in which the output voltage Vout from the driving voltage source is the same, the light emission energy by the rush current supplied to EL elements by one scan can be made approximately the same value, and thus duty control in which almost no variation is produced in intensities of EL elements which are driven to emit light can be realized.

The above-described specific characteristic can guarantee gradation expression whose linearity is high even in gradation control explained below. That is, in gradation control which may be suitably adopted in this embodiment, all scan lines arranged on the display panel are scanned repeatedly a plural number of times so that one screen is displayed, and by controlling the number of lightings of the respective light emitting elements for each scan time, gradation expression is realized.

For example, in order to realize 16 gradations, all scan lines arranged on the display panel are scanned repeatedly 16 times so that one screen is displayed. By controlling the number of scan times within 16 repeating scan times in which EL elements to be scan objects are lit, an image of a display screen can be controlled of brightness of 16 gradations. In this case, whether EL elements being scan objects should be lit or not is determined by control as to whether the respective drive switches Sa1 to San in the data driver 10 are brought to the open state or are connected to the reference potential as already described.

In a case where a larger number of gradations are desired to be produced or where the number of steps of dimmer is desired to be increased, the drive switches Sa1 to San are controlled to be switched from the open state to a state in which all switches are connected to the reference potential in the middle of a scan lighting state of EL elements, and by independently changing the switching time from the open state to the state of all switches connected to the reference potential, brightness different for each dot can be expressed.

Further, as an application example, in a case where a wide-range and linear dimmer change is needed, by varying the output voltage Vout supplied from the driving voltage source, continuous intensity variable setting until a minimum intensity can be performed. Therefore, with the duty control with less variations in this embodiment, by governing intensity, gradation and dimmer, an ideal gamma curve can be obtained accurately and readily. Moreover, for example with a structure in which an anode chip constituting the data driver 10 is divided into plural potions, since time variations in a sequence is very few from the viewpoint of characteristics of a semiconductor, intensity level differences among chips can be dissolved without any regulation.

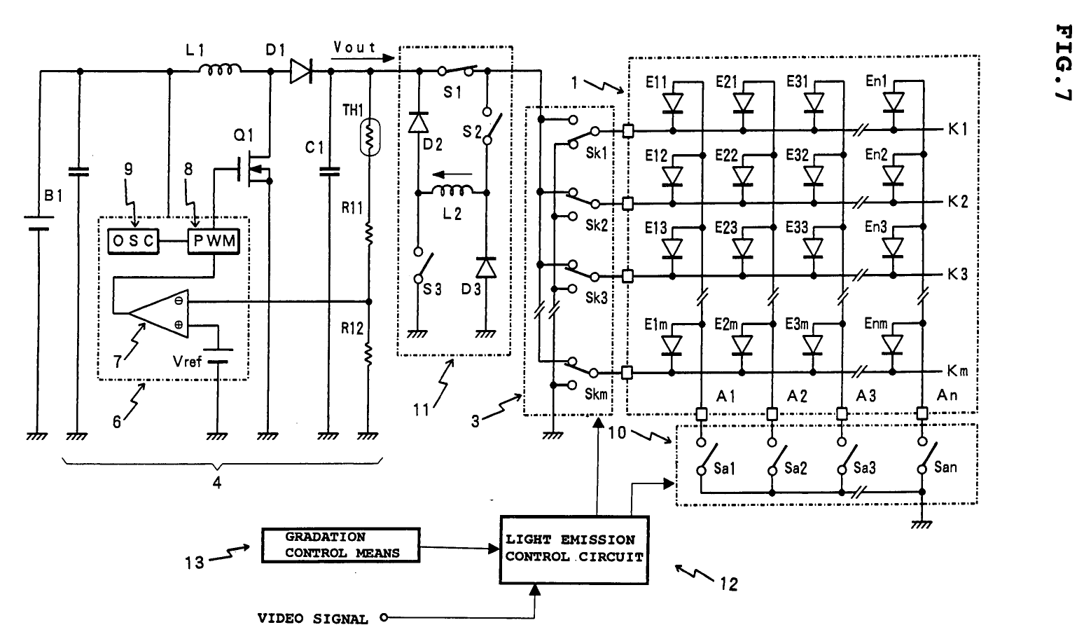

In the above-described gradation control or dimmer control, in a case where light emission intensity is controlled relatively small, the chance that electrical charges accumulated in the parasitic capacitances of respective EL elements are discharged to the reference potential point (ground) becomes increased, which thus is accompanied by a power loss, whereby the utilization efficiency of a primary power source is decreased. In order to solve such technical problems, in the above-described embodiment, it is preferred to adopt a revival means for generating electromotive force, utilizing discharge current of the case where electrical charges accumulated in the parasitic capacitances are discharged, and this revival means will be described in detail with reference to a third embodiment (FIG. 7) of the present invention.

Meanwhile, the forward voltage Vf of the respective EL elements arranged on the display panel 1 changes in accordance with the environmental temperature as already described, and light emission intensity increases in accordance with the increase of the environmental temperature. In order to suppress intensity changes with respect to changes in the environmental temperature, a temperature characteristic of the thermistor TH1 in the driving voltage source shown in FIG. 4 is utilized. That is, the output voltage Vout of the driving voltage source is gradually decreased in accordance with the increase of the environmental temperature. As a result, the EL elements E11 to Emn are driven to be lit approximately at a constant intensity regardless of fluctuations of the environmental temperature.

With the light emission driving operation by the above-described duty control in this embodiment, the light emission intensity can be controlled approximately linearly with respect to the output voltage Vout of the driving voltage source, and by performing temperature correction for the output voltage Vout, a relatively correct temperature correction characteristic can be obtained. In other words, it is easy to readily suppress intensity changes with respect to the environmental temperature as described above, and conversely, it also becomes possible to intentionally control intensity changes with respect to the environmental temperature.

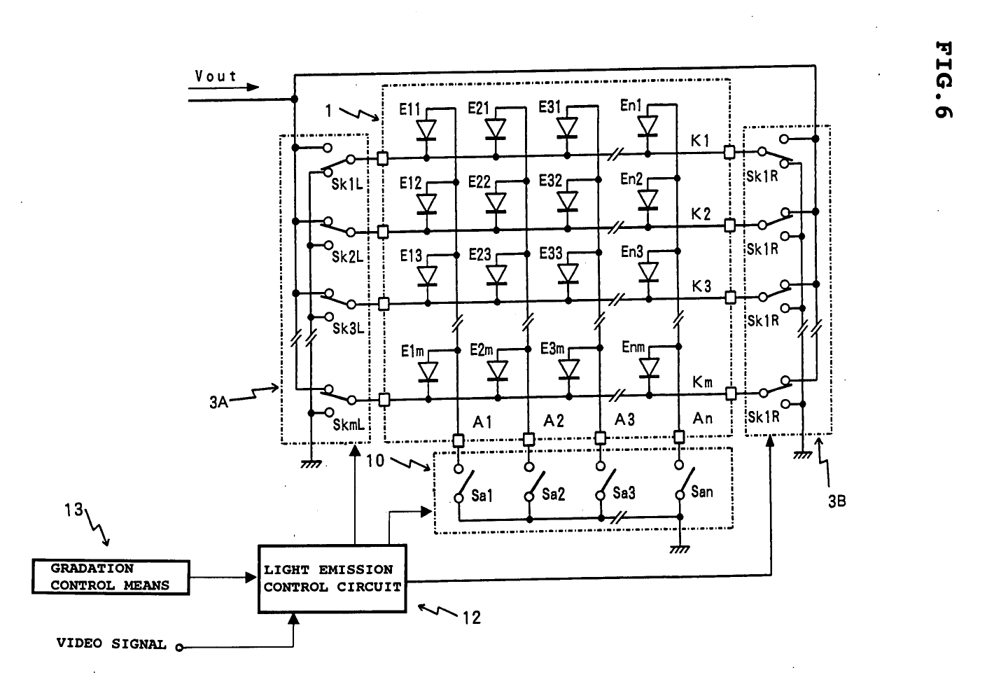

Next, FIG. 6 shows a second embodiment of a drive device of a display panel according to the present invention. In FIG. 6, the structure of the driving voltage source, which supplies the output voltage Vout that has already been described, is omitted. Parts corresponding to respective constituent elements shown in FIG. 4 which has already been described are denoted by the like numerals, and therefore detailed explanation thereof will be omitted appropriately.

In the embodiment shown in this FIG. 6, two scan drivers are employed, and these scan drivers are constructed so as to be respectively connected to both end portions of respective scan lines K1 to Km in the light emitting display panel 1. That is, a first scan driver 3A is arranged in a left side of the light emitting display panel 1 shown in FIG. 6, a second scan driver 3B is arranged in a right side of the light emitting display panel 1, and these drivers are controlled so that the respective scan lines K1 to Km are connected to a scan potential point in synchronization with a command from the light emission control circuit 12.

The first scan driver 3A is provided with scan switches Sk1L to SkmL, corresponding to the respective cathode lines K1 to Km, and constructed to be applied with either the ground potential as the reference potential point or the output voltage Vout of the driving voltage. The second scan driver 3B is similarly provided scan switches Sk1R to SkmR, corresponding to the respective cathode lines K1 to Km, and constructed to be applied with either the ground potential as the reference potential point or the output voltage Vout of the driving voltage source.

In the state shown in FIG. 6, both end portions of the cathode line K1 are allowed to be in the scan state by the first scan driver 3A and the second scan driver 3B, respectively, and the output voltage Vout of the driving voltage source is applied to the other cathode lines K2 to Km by the first scan driver 3A and the second scan driver 3B.

With the structure shown in FIG. 6, at both end portions of the respective cathode lines K1 to Km, the first scan driver 3A and the second scan driver 3B are in synchronism so as to perform operations to connect the respective scan lines to the scan potential point (ground) and to connect scan lines of the non-scan state which are not connected to the scan potential point to the driving voltage source, whereby it can be prevented effectively that intensity slope in the horizontal direction along the scan lines occurs due to a voltage drop generated in the respective cathode lines K1 to Km.

Next, FIG. 7 shows a third embodiment of a drive device of a display panel according to the present invention. In FIG. 7, parts corresponding to respective constituent elements shown in FIG. 4 which has already been described are denoted by the like numerals, and therefore detailed explanation thereof will be omitted appropriately. The embodiment shown in this FIG. 7 shows an example in which adopted is the revival means for generating electromotive force, utilizing discharge current of the case where electrical charges accumulated in the parasitic capacitances of the respective EL elements are discharged as described above.

This revival means 11 lies between the driving voltage source supplying the output voltage Vout as the voltage boosting circuit 4 and the scan driver 3. That is, the revival means 11 is composed of a first switch S1 lying between the driving voltage source and the scan driver 3, a diode D2 whose cathode terminal is connected to the driving voltage source, a third switch S3 connected between the anode terminal of the diode D2 and the reference potential point, a diode D3 whose anode terminal is connected to the reference potential point, a second switch S2 connected between the cathode terminal of the diode D3 and the scan driver 3, and an inductor L2 connected between the cathode terminal of the diode D3 and the anode terminal of the diode D2.

In the reset process in which electrical charges accumulated in the parasitic capacitances of the respective EL elements E11 to Enm arranged on the display panel 1 are discharged, the revival means 11 operates so that the inductor L2 collects the discharge current as electromagnetic energy and at the next moment the capacitor C1 arranged in the driving voltage source is charged by the electromotive force generated in the inductor L2.

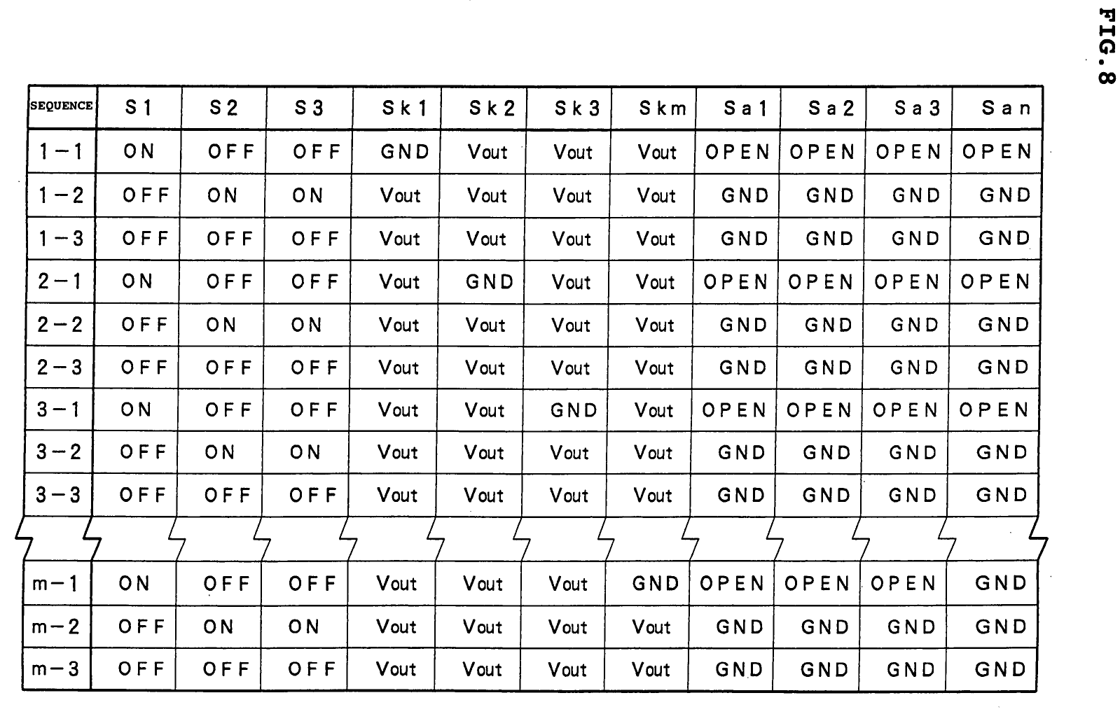

FIG. 8 is to explain in due order a revival operation performed by the revival means 11 with the above-described structure. Respective reference numerals shown in the left column shown in this FIG. 8 represent operation order (sequence) in order from the top to the bottom, and respective reference numerals shown in the top row represent the first switch to the third switch in the revival means 11, the respective scan switches in the scan driver 3, and the respective drive switches in the data driver 10 in order from the left to the right, respectively.

The first switch to the third switch S1 to S3 in the revival means 11 show a state of ON or OFF, and the respective scan switches Sk1 to Skm in the scan driver 3 show a switching state to the output voltage side (Vout) supplied from the driving voltage source or to the reference voltage point (GND). Further, the respective drive switches Sa1 to San in the data driver 10 show the OPEN state or the ON state, that is, a connection state to the reference potential point (GND). The explanation below exemplifies a case where EL elements connected to the scan lines are all lit.

In sequence 1-1 shown in FIG. 8, the respective EL elements E11, E21, E31, . . . En1 connected to the first scan line K1 are all brought to a lighting state. Thereafter, in sequence 1-2, current by electrical charges accumulated in the parasitic capacitances in the respective EL elements E11 to Enm arranged on the display panel 1 flows in the inductor L2 in the arrow direction so that the reset operation is implemented. Thus, the electrical charges accumulated in the parasitic capacitances of the respective EL elements are discharged. At the same time as this operation, the inductor L2 collects discharge current flowing in the inductor L2 as electromagnetic energy.

In this case, a resonance frequency is defined by all parasitic capacitances of the respective EL elements and the inductance of the inductor L2, and the time until reaching a maximum value of the current flowing in the inductor L2 in the arrow direction is determined. Therefore, an optimum continuation time of this sequence 1-2 is always constant and the continuation time can be set by timing control utilizing a clock.

Sequence 1-3 is operated in such a way that collection energy by the inductor L2, that is, the electromotive force generated in the inductor L2, charges the capacitor C1 arranged in the driving voltage source via the diodes D2 and D3. At this time, by the operations of the diodes D2 and D3, current is prevented from flowing from the capacitor C1 side to the ground side.

In the next sequence 2-1 shown in FIG. 8, the respective EL elements E12, E22, E32, . . . En2 connected to the second scan line K2 are all brought to the lighting state. In the following sequence 2-2, by an operation similar to the above-described sequence 1-2, the reset operation and an operation of collecting energy as electromagnetic energy by the inductor L2 are performed. By an operation similar to the above-described sequence 1-3, sequence 2-3 operates so as to charge the capacitor C1 by the electromotive force generated in the inductor L2.

In the following sequences 3-1 to 3-3, . . . m-1 to m-3 shown in FIG. 8, operations similar to those described above are repeated, and thus one time scan for all scan lines of the display panel is completed. As mentioned above, for example in order to implement gradation expression of 16 gradations, control is performed so that repeating the above-described scan 16 times makes display of one screen. As already described, by controlling the number of scan times within 16 repeating scan times in which EL elements to be scan objects are lit, an image of a display screen can be controlled of brightness of 16 gradations.

With the structure equipped with the revival means 11 shown in FIG. 7, even in a case where light emission intensity is controlled relatively small in gradation expression, electrical charges accumulated in the parasitic capacitances of the respective EL elements are supplied to the revival means 11, and electromotive force by this supply can be returned to the driving voltage source. Accordingly, the utilization efficiency of the power source can be improved drastically.

Even in the embodiment shown in FIG. 7 described above, the structure in which two scan drivers 3A, 3B are employed as shown in FIG. 6 can be adopted, and in this case, it can be prevented effectively that intensity slope in the horizontal direction along the scan lines occurs as described with reference to FIG. 6.

In the respective embodiments shown in FIGS. 4, 6, and 7, although the drive switches Sa1 to San in the data driver 10 are constructed so as to select the ground potential or the open state, similar operations and effects can be obtained even in a structure in which the drive switches Sa1 to San are selectively connected to a low voltage source whose voltage is close to the ground potential and a voltage source whose voltage is close to the output voltage Vout supplied from the driving voltage source.

Further, although the embodiments described above exemplify a cathode line scan/anode line drive form, the drive device and drive method of the display panel according to the present invention can also be adopted in the display device of an anode line scan/cathode line drive form.

What is claimed is:

1. A drive device of a light emitting display panel provided with a plurality of data lines and a plurality of scan lines which intersect one another and capacitive light emitting elements having a diode characteristic which are respectively connected at intersecting positions between the respective data lines and the respective scan lines, characterized in that the drive device are provided
a scan driver which performs scan one after another by connecting the respective scan lines to a scan potential point as well as connecting a scan line of a non-scan state which is not connected to the scan potential point to a driving voltage source and a data driver which controls lighting or non-lighting of the respective light emitting elements of a scan state in synchronization with a scan of the scan driver
and by being constructed in such a way that the scan driver and the data driver set all scan lines and all data lines at a same electrical potential when a scan is switched so that electrical charges accumulated in parasitic capacitances of the respective light emitting elements are discharged and that charge current which follows the discharge of electrical charges, which is from the driving voltage source, and which charges parasitic capacitances of light emitting elements in the non-scan state is supplied as a forward current to a light emitting element which is scanned and lit so that the light emitting element is driven to emit light, utilizing the driving voltage source.

2. The drive device of the light emitting display panel according to claim 1, characterized by being constructed in such a way that the scan driver and the data driver connect all scan lines and all data lines to the scan potential point, respectively, when a scan is switched so that the scan lines and the data lines are set at a same electrical potential.

3. The drive device of the light emitting display panel according to claim 1, characterized by being constructed in such a way that in a drive device of the light emitting display panel of a cathode line scan/anode line drive form in which cathodes of the respective light emitting elements are connected to the respective scan lines, the data driver connects the data lines to the scan potential point or sets the data lines in an open state so that a light emitting element of the scan state is controlled not to be lit or to be lit.

4. The drive device of the light emitting display panel according to claim 2, characterized by being constructed in such a way that in a drive device of the light emitting display panel of a cathode line scan/anode line drive form in which cathodes of the respective light emitting elements are connected to the respective scan lines, the data driver connects the data lines to the scan potential point or sets the data lines in an open state so that a light emitting element of a scan state is controlled to be lit or not to be lit.

5. The drive device of the light emitting display panel according to any one of claims 1 to 4, characterized in that the drive device further comprising a gradation control means which can change repeating times of scans within a unit time.

6. The drive device of the light emitting display panel according to any one of claims 1 to 4, characterized by being constructed in such a way that the scan driver is composed of a first scan driver and a second scan driver which are connected to both end portions of respective scan lines, respectively, in the light emitting display panel and that the first scan driver and the second scan driver are in synchronism so as to perform operations to connect the respective scan lines to the scan potential point and to connect scan lines of the non-scan state which are not connected to the scan potential point to the driving voltage source.

7. The drive device of the light emitting display panel according to claim 5, characterized by being constructed in such a way that the scan driver is composed of a first scan driver and a second scan driver which are connected to both end portions of respective scan lines, respectively, in the light emitting display panel and that the first scan driver and the second scan driver are in synchronism so as to perform operations to connect the respective scan lines to the scan potential point and to connect scan lines of the non-scan state which are not connected to the scan potential point to the driving voltage source.

8. The drive device of the light emitting display panel according to any one of claims 1 to 4, characterized by being constructed in such a way that a revival means for generating electromotive force, utilizing discharge current of a case where electrical charges accumulated in parasitic capacitances of the respective light emitting elements are discharged is provided and that the electromotive force generated by the revival means is returned to the driving voltage source.

9. The drive device of the light emitting display panel according to claim 5, characterized by being constructed in such a way that a revival means for generating electromotive force, utilizing discharge current of a case where electrical charges accumulated in parasitic capacitances of the respective light emitting elements are discharged is provided and that the electromotive force generated by the revival means is returned to the driving voltage source.

10. The drive device of the light emitting display panel according to claim 6, characterized by being constructed in such a way that a revival means for generating electromotive force, utilizing discharge current of a case where electrical charges accumulated in parasitic capacitances of the respective light emitting elements are discharged is provided and that the electromotive force generated by the revival means is returned to the driving voltage source.

11. The drive device of the light emitting display panel according to claim 7, characterized by being constructed in such a way that a revival means for generating electromotive force, utilizing discharge current of a case where electrical charges accumulated in parasitic capacitances of the respective light emitting elements are discharged is provided and that the electromotive force generated by the revival means is returned to the driving voltage source.

12. The drive device of the light emitting display panel according to claim 8, characterized by being constructed in such a way that an inductor which collects the discharge current as electromagnetic energy is provided in the revival means and that electromotive force generated in the inductor charges a capacitor arranged in the driving voltage source.

13. The drive device of the light emitting display panel according to claim 9, characterized by being constructed in such a way that an inductor which collects the discharge current as electromagnetic energy is provided in the revival means and that electromotive force generated in the inductor charges a capacitor arranged in the driving voltage source.

14. The drive device of the light emitting display panel according to claim 10, characterized by being constructed in such a way that an inductor which collects the discharge current as electromagnetic energy is provided in the revival means and that electromotive force generated in the inductor charges a capacitor arranged in the driving voltage source.

15. The drive device of the light emitting display panel according to claim 11, characterized by being constructed in such a way that an inductor which collects the discharge current as electromagnetic energy is provided in the revival means and that electromotive force generated in the inductor charges a capacitor arranged in the driving voltage source.

16. The drive device of the light emitting display panel according to any one of claims 1 to 4, characterized in that light emitting elements constituting the light emitting display panel are organic EL elements.

17. The drive device of the light emitting display panel according to claim 5, characterized in that light emitting elements constituting the light emitting display panel are organic EL elements.

18. A drive method of a light emitting display panel provided with a plurality of data lines and a plurality of scan lines which intersect one another and capacitive light emitting elements having a diode characteristic which are respectively connected, between the data lines and respective scan lines, at intersecting positions between the respective data lines and respective scan lines, the drive method of the light emitting display panel characterized by performing
a reset process in which while the scan lines of the display panel are scanned at predetermined cycles, lighting or non-lighting of the respective light emitting elements of a scan state is controlled in synchronization with the scan and in which all scan lines and all data lines are set at a same electrical potential when the scan is switched so that electrical charges accumulated in parasitic capacitances of the respective light emitting elements are discharged and a process which follows this reset process and in which parasitic capacitances of light emitting elements in a non-scan state are charged, utilizing a drive voltage from a driving voltage source, the charge current being supplied to an light emitting element which is scanned and lit as a forward current so that a light emitting element in the display panel is driven to emit light by the charge current.

19. The drive method of the light emitting display panel according to claim 18, characterized in that, in the reset process in which the electrical charges accumulated in the parasitic capacitances of the respective light emitting elements are discharged, an operation of collecting the discharge current as electromagnetic energy by an inductor and an operation of returning electromotive force generated in the inductor to the driving voltage source are performed.

20. The drive method of the light emitting display panel according to claim 18 or 19, characterized in that all scan lines arranged on the display panel are repeatedly scanned a plural number of times to perform display of one screen and that the number of lightings of the respective light emitting elements for each scan is controlled so that gradation expression is realized.
